(19) United States
(12) Patent Application Publication
(10) Pub. No.: US 2024/0120798 A1
(43) Pub. Date: Apr. 11, 2024

(54) MOTOR, MOTOR UNIT, VEHICLE DRIVING MOTOR UNIT AND ELECTRIC VEHICLE

(71) Applicant: YAMAHA HATSUDOKI KABUSHIKI KAISHA, Iwata-shi (JP)

(72) Inventors: Takuro KAMICHIKA, Shizuoka (JP); Shinichi KUROSAWA, Shizuoka (JP); Shogo TANINO, Shizuoka (JP)

(21) Appl. No.: 18/542,826

(22) Filed: Dec. 18, 2023

Related U.S. Application Data
(63) Continuation of application No. PCT/JP2022/014123, filed on Mar. 24, 2022.

(30) Foreign Application Priority Data
Jun. 21, 2021 (JP) 2021-102791

(51) Int. Cl. H02K 5/20; B60K 1/02; H02K 7/116; H02K 9/19

(52) U.S. Cl. CPC H02K 5/203; B60K 1/02; H02K 7/116; H02K 9/19

(57) ABSTRACT

A vehicle driving motor unit for an electric vehicle includes a plurality of motor units each including a motor. The motor includes a rotor including a first oil path, a second motor cover including second and third oil paths connected to an outward oil path, and a cover including a fourth oil path between the first and second oil paths, and a fifth oil path between the first and third oil paths. The second and fourth oil paths communicate with each other via a first gasket. The second and third oil paths include, respectively, open ends connected to an exit end of a first pipe and an inlet end of a second pipe. The third and fifth oil paths communicate with each other via a second gasket.

### CROSS REFERENCE TO RELATED APPLICATIONS

This application claims the benefit of priority to Japanese Patent Application No. 2021-102791 filed on Jun. 21, 2021 and is a Continuation Application of PCT Application No. PCT/JP2022/014123 filed on Mar. 24, 2022. The entire contents of each application are hereby incorporated herein by reference.

### BACKGROUND OF THE INVENTION

### 1. Field of the Invention

The present invention relates to motors, motor units, vehicle driving motor units, and electric vehicles, and more specifically to oil-cooled motors, motor units, vehicle driving motor units, and electric vehicles.

### 2. Description of the Related Art

As an example which is pertinent to conventional techniques of this kind, JP-A 2021-52523 discloses a driving apparatus. The driving apparatus includes a motor having a rotor and a stator radially outside the rotor, a housing which houses the motor, and a cooling medium flow path passing inside the housing and including a cooling medium. The housing has an inner circumferential surface, the stator has an outer circumferential surface, and the surfaces are radially opposed to each other. The cooling medium flow path includes an injection hole for injection of the cooling medium between the housing's inner circumferential surface and the stator's outer circumferential surface, and a guide flow path located between the housing's inner circumferential surface and the stator's outer circumferential surface. The guide flow path is a groove which is at least in one of the housing's inner circumferential surface and the stator's outer circumferential surface, and extending in a circumferential direction.

JP-A 2021-52523 does not mention a case in which the driving apparatuses are arranged in a side-by-side layout.

### SUMMARY OF THE INVENTION

Therefore, preferred embodiments of the present invention provide motors that are suitably arranged in a side-by-side layout, and motor units, vehicle driving motor units, and electric vehicles including the same.

According to a preferred embodiment of the present invention, a motor which includes a case including a stator housing, a first motor cover at an output end of the stator housing, and a second motor cover at a non-output end of the stator housing; a first pipe including an outward oil path and held by the first motor cover and the second motor cover; a second pipe including a return oil path, located lower than the first pipe, and held by the first motor cover and the second motor cover; a rotor inside the case and including a first oil path; a stator inside the case and including a stator core radially outside the rotor, and a stator coil in the stator core; a cover outside the second motor cover; and a gasket between the second motor cover and the cover. The second motor cover includes a second oil path and a third oil path connected to the outward oil path. The cover includes a fourth oil path between the first oil path and the second oil path, and a fifth oil path between the first oil path and the third oil path. The gasket includes a through-hole enabling either one of communication between the second oil path and the fourth oil path, or communication between the third oil path and the fifth oil path. The second oil path includes an open end and the third oil path includes an open end respectively connected to one of an exit end of the first pipe and the other of an inlet end of the second pipe.

Preferred embodiments of the present invention are suitable for a case where two motors are arranged in a side-by-side layout. In this arrangement, a first one of the motors is located so that its second oil path is higher than the third oil path, the first pipe has its exit end connected to the open end of the second oil path, and the second pipe has its inlet end connected to the open end of the third oil path. The gasket between the second motor cover and the cover provides communication between the second oil path and the fourth oil path via the through-hole, but blocks communication between the third oil path and the fifth oil path. Therefore, oil from the outward oil path of the first pipe is supplied into the case via the second oil path of the second motor cover, the fourth oil path of the cover, and the first oil path of the rotor. In this arrangement, oil does not flow from the third oil path to the fifth oil path. In a second one of the motors, the stator housing and the second motor cover of the first motor are rotated by 180 degrees (flipped upside down), and the first pipe and the second pipe are swapped with each other. In other words, the second motor is located so that its third oil path is higher than the second oil path, the first pipe has its exit end connected to the open end of the third oil path, and the second pipe has its inlet end connected to the open end of the second oil path. The gasket provides communication between the third oil path and the fifth oil path via the through-hole, but blocks communication between the second oil path and the fourth oil path. Therefore, oil from the outward oil path is supplied into the case via the third oil path of the second motor cover, the fifth oil path of the cover, and the first oil path of the rotor. In this arrangement, oil does not flow from the second oil path to the fourth oil path. As described above, it is possible with the gasket to change an oil route from the outward oil path to the first oil path so that the route is provided by the oil path which is on a gravitationally upper side, thus making it possible to suitably use the two motors in a side-by-side layout.

Preferably, the second motor cover further includes a sixth oil path and a seventh oil path connected to the outward oil path to supply oil to the stator coil. The sixth oil path is adjacent the second oil path, and the seventh oil path is adjacent the third oil path. In this case, in the first motor, oil from the outward oil path is smoothly supplied to the stator coil via the sixth oil path of the second motor cover, while in the second motor, oil from the outward oil path is smoothly supplied to the stator coil via the seventh oil path of the second motor cover. As described above, it is possible to switch between the two oil paths to the stator coil, and it is possible to smoothly supply oil to the stator coil too.

Further preferably, the motor further includes a branched portion inside the second motor cover to direct the oil from the outward oil path to the second and sixth oil paths, or to the third and seventh oil paths. In this case, in the first motor, the branched portion is between the outward oil path and the second and sixth oil paths such that it is possible to easily divide oil from the outward oil path to the second oil path and to the sixth oil path. In the second motor, the branched portion is between the outward oil path and the third and seventh oil paths such that it is possible to easily direct oil from the outward oil path to the third oil path and to the seventh oil path.

Further, preferably, the open ends of the second oil path and the third oil path are in point symmetry to each other with respect to an axis of the rotor when viewed axially along the rotor. In this case, even if the motor is rotated by 180 degrees (flipped upside down), it is possible to supply oil into the case from a similar position.

According to another preferred embodiment of the present invention, a motor unit includes the above described motor, and a speed reducer on a side of the first motor cover to slow rotation of the rotor and connected to the return oil path.

According to preferred embodiments of the present invention, it is possible to smoothly supply oil to the speed reducer.

According to another preferred embodiment of the present invention, a vehicle driving motor unit includes a plurality of the above-described motor units in which the stator housings, the second motor covers, and the covers of the motors are identical.

In a preferred embodiment of the present invention, all of the motors, and therefore all of the motor units, use identical stator housings, second motor covers, and covers. Therefore, it is possible to easily obtain a vehicle driving motor unit including a plurality of the motor units.

According to a preferred embodiment of the present invention, the vehicle driving motor unit described above can be suitably utilized in an electric vehicle.

It should be noted here that in preferred embodiments of the present invention, “output end of the stator housing” refers to an axial end of the stator housing from which the motor output is taken off.

“Non-output end of the stator housing” refers to an axial end of the stator housing from which the motor output is not taken off (an axial end on a side away from the output end).

Preferred embodiments of the present invention provide motors which can be suitably used in a side-by-side layout, and motor units, vehicle driving motor units, and electric vehicles including the same.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view which shows a vehicle according to a preferred embodiment of the present invention.

FIG. 2 is a perspective view which shows a vehicle driving motor unit included in the vehicle in FIG. 1.

FIG. 3 is a front perspective view which shows a first motor unit included in the vehicle driving motor unit in FIG. 2.

FIG. 4 is a rear perspective view which shows the motor unit in FIG. 3.

FIG. 5 is a right side view which shows the motor unit in FIG. 3.

FIG. 6 is a left side view which shows the motor unit in FIG. 3.

FIG. 7 is an illustrative sectional view which shows the motor unit in FIG. 3.

FIG. 8 is a plan view which shows a gasket included in the motor unit in FIG. 3.

FIG. 9 is a front perspective view which shows a second motor unit included in the vehicle driving motor unit in FIG. 2.

FIG. 10 is a rear perspective view which shows the motor unit in FIG. 9.

FIG. 11 is a left side view which shows the motor unit in FIG. 9.

FIG. 12 is a right side view which shows the motor unit in FIG. 9.

FIG. 13 is an illustrative sectional view which shows the motor unit in FIG. 9.

FIG. 14 is a plan view which shows a gasket included in the motor unit in FIG. 9.

### DETAILED DESCRIPTION OF THE PREFERRED EMBODIMENTS

Hereinafter, preferred embodiments of the present invention will be described with reference to the drawings.

In the drawings, “Fr” indicates forward, “Rr” indicates rearward, “R” indicates rightward, “L” indicates leftward, “U” indicates upward, and “Lo” indicates downward.

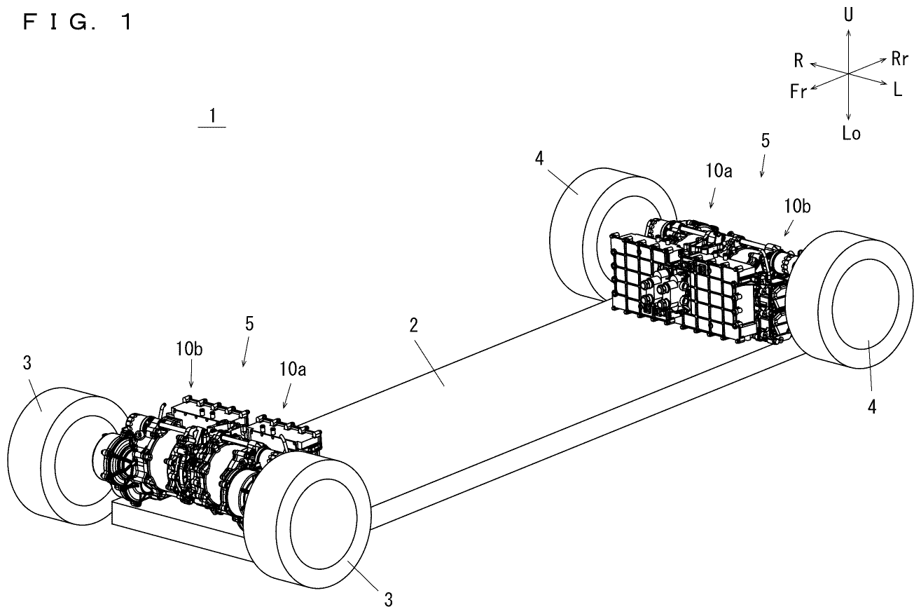

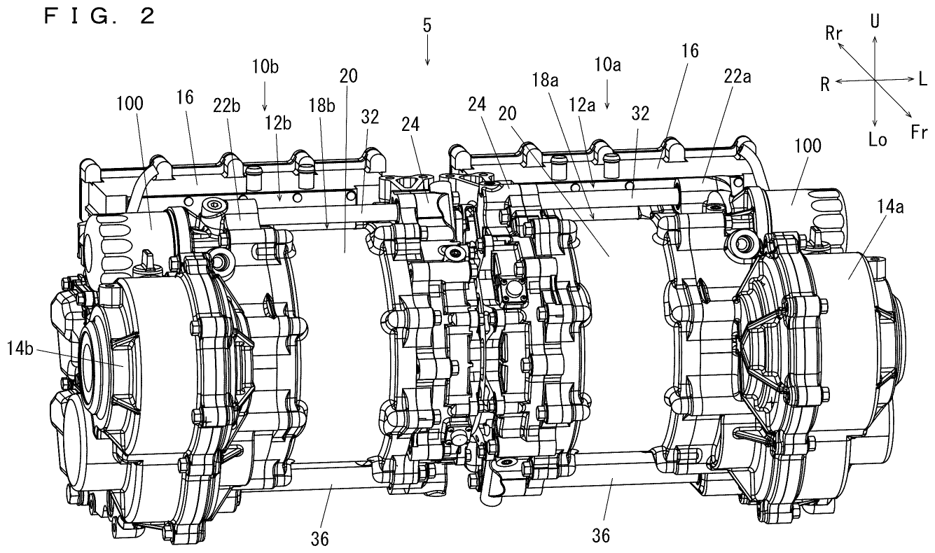

Referring to FIG. 1, an electric vehicle 1 according to a preferred embodiment of the present invention includes a body 2, a pair of front wheels 3, a pair of rear wheels 4, a vehicle driving motor unit 5 provided between the pair of front wheels 3 at a front portion of the body 2, and a vehicle driving motor unit 5 provided between the pair of rear wheels 4 at a rear portion of the body 2. The pair of front wheels 3 and the pair of rear wheels 4 are driven by a respective one of the vehicle driving motor units 5. Referring also to FIG. 2, the vehicle driving motor unit 5 includes motor units 10a, 10b which are placed side by side.

As shown in FIG. 1, the vehicle driving motor unit 5 provided between the pair of front wheels 3, and the vehicle driving motor unit 5 provided between the pair of rear wheels 4 have an identical structure although their front and back are reversed. Therefore, description herein will be made for the vehicle driving motor unit 5 provided between the pair of front wheels 3, and description for the vehicle driving motor unit 5 provided between the pair of rear wheels 4 will be skipped.

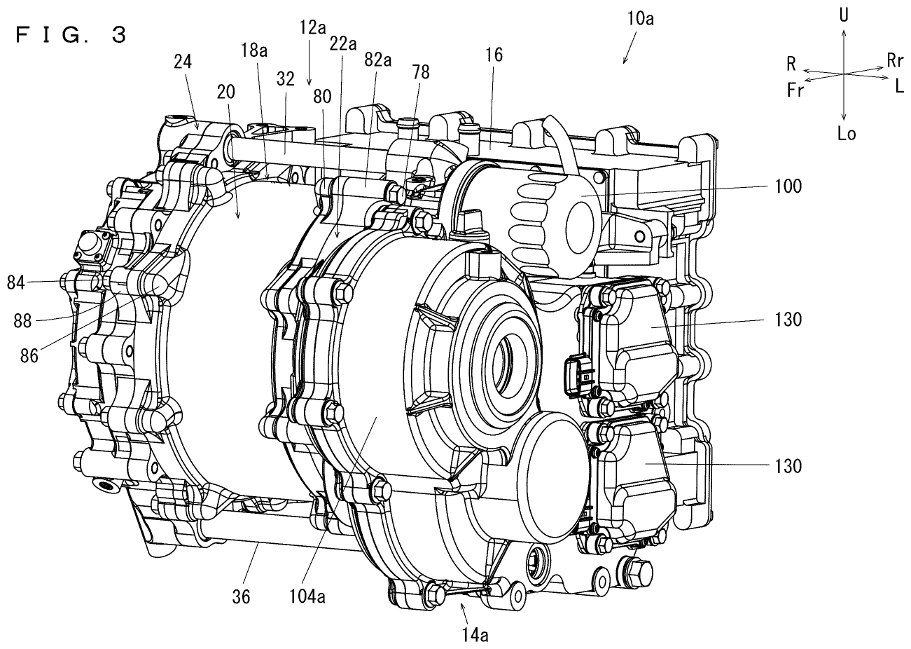

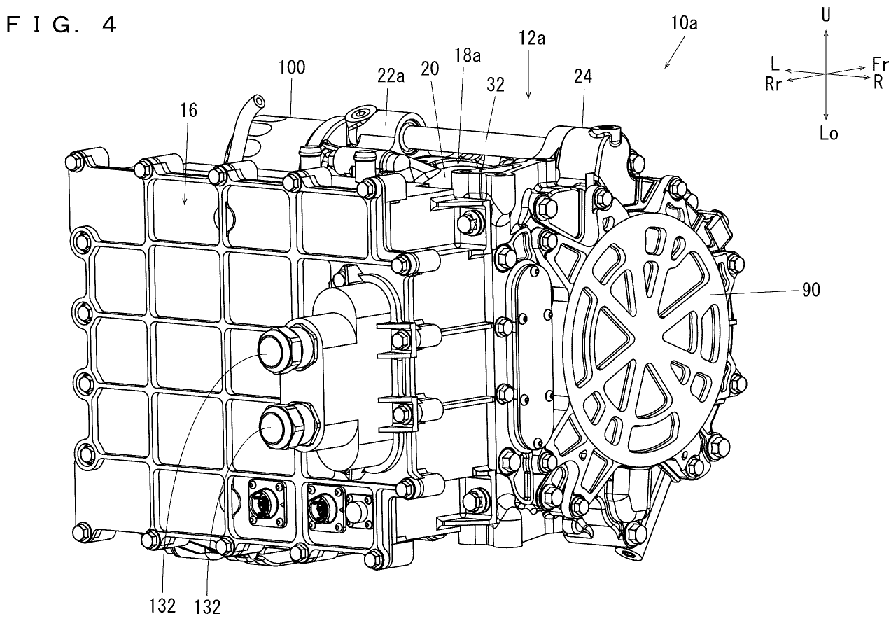

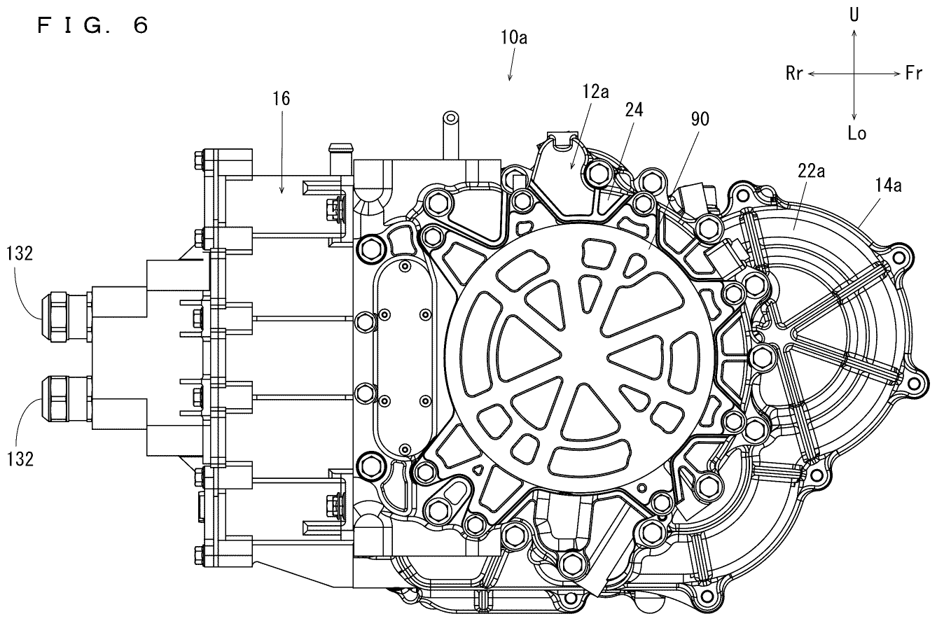

Referring to FIG. 3 through FIG. 6, the motor unit 10a is a mechatronic integrated unit including a motor 12a, a speed reducer 14a, and an inverter 16. The speed reducer 14a is provided on a side (left side in the present preferred embodiment) of the motor 12a, while the inverter 16 is provided behind the motor 12a and the speed reducer 14a.

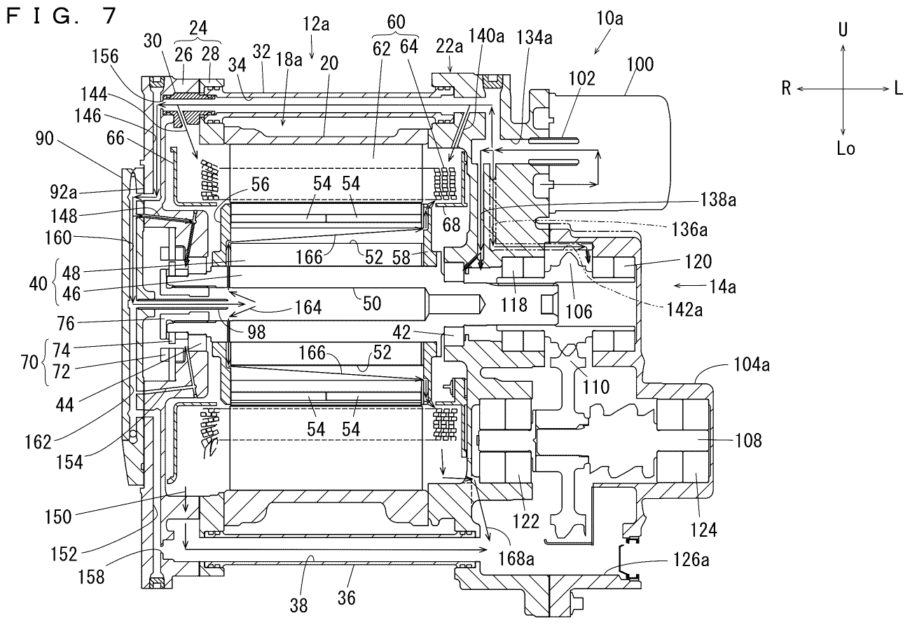

Referring also to FIG. 7, the motor 12a includes a case 18a. The case 18a has a three-tier structure, and includes a stator housing 20, a first motor cover 22a provided at an output end of the stator housing 20, and a second motor cover 24 provided at a non-output end of the stator housing 20. The second motor cover 24 includes a cover main body 26, and a pipe holder 28 attached to the cover main body 26. A branched portion 30 is provided between the cover main body 26 and the pipe holder 28.

Outside the stator housing 20, a first external pipe 32 is held by the first motor cover 22a and the second motor cover 24. The first external pipe 32 is separate from the stator housing 20, located slightly spaced away from the stator housing 20, and sandwiched by the first motor cover 22a and the second motor cover 24. The first external pipe 32 includes an outlet end held by the pipe holder 28 and connected with the branching portion 30. Inside the first external pipe 32, an outward oil path 34 provides communication between the first motor cover 22a and the second motor cover 24. Also, outside the stator housing 20, at a position lower than the first external pipe 32, a second external pipe 36 is held by the first motor cover 22a and the second motor cover 24. The second external pipe 36 is separate from the stator housing 20, located slightly spaced away from the stator housing 20, and sandwiched by the first motor cover 22a and the second motor cover 24. The second external pipe 36 includes an inlet end held by the pipe holder 28. Inside the second external pipe 36, a return oil path 38 provides communication between the first motor cover 22a and the second motor cover 24. The return oil path 38 is provided at a lower position than the outward oil path 34. Preferably, the outward oil path 34 has a smaller cross sectional area than the return oil path 38. In other words, preferably, an inner diameter of the first external pipe 32 is smaller than an inner diameter of the second external pipe 36.

A rotor 40 is provided inside the case 18. The rotor 40 is held rotatably by the first motor cover 22a and the second motor cover 24 via motor bearings 42, 44. The rotor 40 includes a rotor shaft 46 and a rotor core 48. The rotor shaft 46 includes an axially extending hollow portion 50. The rotor core 48 includes a plurality of rotor core holes 52 and a plurality of magnets 54. End plates 56, 58 are disposed at two axial ends of the rotor core 48.

Inside the case 18, a stator 60 is provided radially outside the rotor 40. The stator 60 includes a stator core 62 provided radially outside the rotor 40 and fixed to the stator housing 20, and a stator coil 64 which is wound around the stator core 62. The stator core 62 is fixed to the stator housing 20 by a shrink fit, for example. Coil end covers 66, 68 cover two axial ends of the stator coil 64, i.e., to cover the coil ends.

Between the second motor cover 24 and the rotor shaft 46, a resolver 70 is provided to detect a rotating angle of the rotor shaft 46. The resolver 70 includes a resolver stator 72 attached to the second motor cover 24, and a resolver rotor 74 attached to the rotor shaft 46. The resolver rotor 74 is fixed to a rear end portion of the rotor shaft 46 by, for example, a bolt 76 which has a generally hat-shaped portion.

Referring to FIG. 3, the stator housing 20 and the first motor cover 22a are connected with each other by a plurality of bolts 78, for example. Each bolt 78 is threaded into a boss 80 provided on an output end in an outer circumferential surface of the stator housing 20, and a boss 82a provided on an outer circumferential portion of the first motor cover 22a. The stator housing 20 and the second motor cover 24 are connected to each other with a plurality of bolts 84, for example. Each bolt 84 is threaded into a boss 86 provided on a non-output end in an outer circumferential surface of the stator housing 20, and a boss 88 provided on an outer circumferential portion of the second motor cover 24.

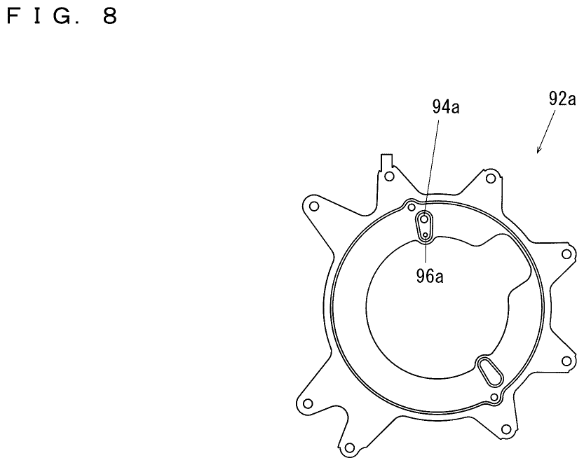

Referring to FIG. 7, a cover 90 is provided on a side of the second motor cover 24. A first gasket 92a is between the second motor cover 24 and the cover 90. Referring to FIG. 8, the gasket 92a has an annular or substantially annular shape, and includes through-holes 94a, 96a in communication with oil paths. A pipe 98 extending into the hollow portion 50 of the rotor shaft 46 is attached at a center portion of the cover 90.

In an outer surface of the first motor cover 22a, an oil filter 100 is provided to filter oil which is to be supplied into the case 18. The oil filter 100 is supplied with oil from an oil cooler (not illustrated) provided outside the motor unit 10a. The oil cooler is shared by the motor unit 10a and the motor unit 10b. The oil filter 100 and the first motor cover 22a are connected with each other by a union bolt 102, for example.

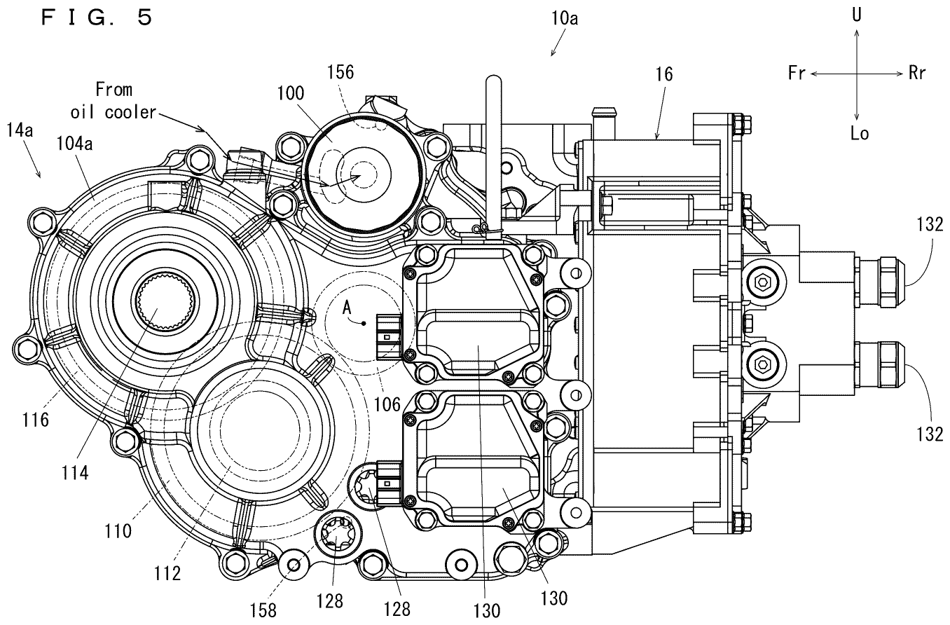

The speed reducer 14a is provided on a side (left side in the present preferred embodiment) of the first motor cover 22a to slow rotation of the rotor. The speed reducer 14a includes a gear cover 104a provided on a side of the first motor cover 22a. Referring to FIG. 5 and FIG. 7, the gear cover 104a is provided therein with an input gear 106, an intermediate shaft 108, intermediate gears 110, 112, an output shaft 114, and an output gear 116. The intermediate shaft 108 and the output shaft 114 are parallel or substantially parallel to the rotor shaft 46. The input gear 106 is attached to a tip portion of the rotor shaft 46, and is supported rotatably by the first motor cover 22a and the gear cover 104a via input gear bearings 118, 120. The intermediate shaft 108 is supported rotatably by the first motor cover 22a and the gear cover 104a via intermediate gear bearings 122, 124. The intermediate gears 110, 112 are both attached to the intermediate shaft 108. The intermediate gear 110 meshes with the input gear 106. The intermediate gear 112 meshes with the output gear 116. The output shaft 114 is supported rotatably by the first motor cover 22a and the gear cover 104a via unillustrated bearings. The output gear 116 is attached to the output shaft 114. The gear cover 104a covers an outer surface of the first motor cover 22a to define an oil reservoir 126a that connects to the return oil path 38. In other words, the oil reservoir 126a is inside the speed reducer 14a. The oil reservoir 126a stores oil from the case 18a and oil from the gear cover 104a.

The gear cover 104a is provided with two oil level gauges 128 to detect an amount of oil inside the oil reservoir 126a. Also, the gear cover 104a is provided with two oil pumps 130 to supply oil from inside the oil reservoir 126a to the external oil cooler.

The inverter 16 is connected with a battery (not illustrated) via connecting terminals 132, converts a direct current from the battery into an alternating current, and supplies the current to the motor 12a.

The motor unit 10a described thus far includes the following oil paths.

Referring to FIG. 7, the first motor cover 22a includes an oil path 134a connected to the outward oil path 34 to supply oil from the oil filter 100 to the outward oil path 34, and oil paths 136a, 138a, 140a branching from the oil path 134a. The oil path 136a is connected to an oil path 142a inside the speed reducer 14a to supply oil to the input gear bearing 120. Oil from the oil path 138a is supplied to the motor bearing 42 and the input gear bearing 118. Oil from the oil path 140a is supplied to the coil end of the stator coil 64. Oil is supplied into the case 18a via the oil paths 138a, 140a. Oil from the oil path 134a flows through the outward oil path 34 and is supplied to the second motor cover 24.

The second motor cover 24 includes oil paths 144, 146, 148, 150, 152, 154. The oil paths inside the second motor cover 24 are symmetrical or substantially symmetrical between an upper half and a lower half, with the oil paths 150, 152, 154 corresponding to the oil paths 144, 146, 148 respectively. The oil path 144 is adjacent to the oil path 146, while the oil path 150 is adjacent to the oil path 152. When viewed axially along the rotor 40, an open end 156 of the oil path 146 and an open end 158 of the oil path 152 are in point symmetry to each other about an axis A of the rotor 40 (see FIG. 5). In the motor unit 10a, the oil paths 144, 146 communicate with the outward oil path 34 via the branched portion 30. Also, the open end 156 of the oil path 146 communicates with an exit-end of the first external pipe 32 via the branched portion 30, while the open end 158 of the oil path 152 communicates with an inlet-end of the second external pipe 36.

The cover 90 includes oil paths 160, 162. The oil paths inside the cover 90 are symmetrical or substantially symmetrical between an upper half and a lower half. The oil path 160 is between an oil path 164 (which will be described below) and the oil path 146, while the oil path 162 is between the oil path 164 and the oil path 152.

The gasket 92a connects the oil path 146 to the oil path 160, and the oil path 160 to the oil path 148 by the through-holes 94a, 96a, but does not connect the oil path 152 to the oil path 162, and the oil path 162 to the oil path 154.

In the motor unit 10a, the oil paths of the upper halves inside the second motor cover 24 and the cover 90 in the state shown in FIG. 7 are utilized.

Oil which flows through the outward oil path 34 and is supplied to the second motor cover 24 is divided by the branched portion 30, supplied to the coil end of the stator coil 64 via the oil path 144, and sent toward the cover 90 via the oil path 146. The oil path 160 connects the oil paths 146 and 148 with each other. In other words, the oil path 146 and the oil path 160 communicate with each other via the through-hole 94a of the gasket 92a, while the oil path 160 and the oil path 148 communicate with each other via the through-hole 96a of the gasket 92a. Therefore, the oil paths 146 and 148 of the second motor cover 24 communicate with each other via the oil path 160 of the cover 90, and oil from the oil path 146 is supplied to the motor bearing 44 and its surroundings via the oil paths 160, 148. Also, the oil path 160 communicates with the oil path 164 inside the hollow portion 50 of the rotor shaft 46 via the pipe 98, and further, communicates with an oil path 166 which leads to the coil end of the stator coil 64, via the rotor core hole 52. Therefore, oil from the oil path 160 is supplied to the coil end of the stator coil 64 via the oil paths 164, 166. As described, oil from the outward oil path 34 is supplied into the case 18a via the second motor cover 24 and the cover 90.

Oil which is supplied to the coil end of the stator coil 64 is then supplied to the oil reservoir 126a via the oil path 150 and the return oil path 38, or via an oil path 168a of the first motor cover 22a. Oil in the oil reservoir 126a is pumped by the two oil pumps 130, supplied to and cooled by the shared oil cooler, and then returned to the oil filter 100.

Next, the motor unit 10b will be described.

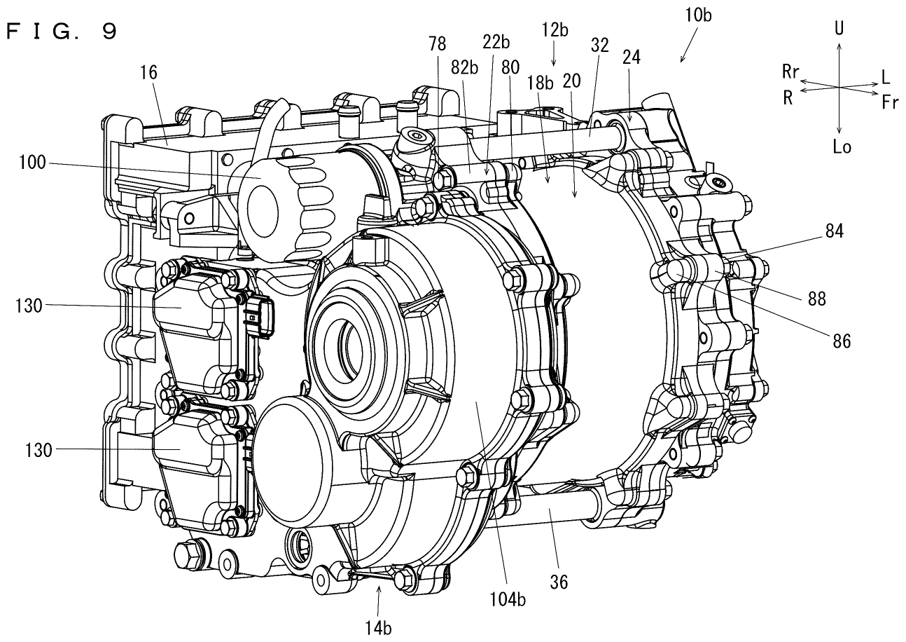

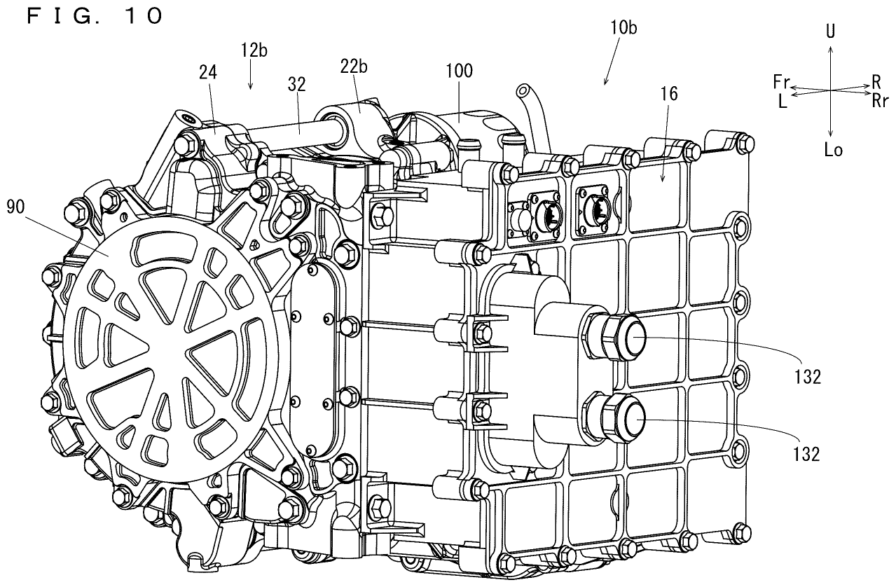

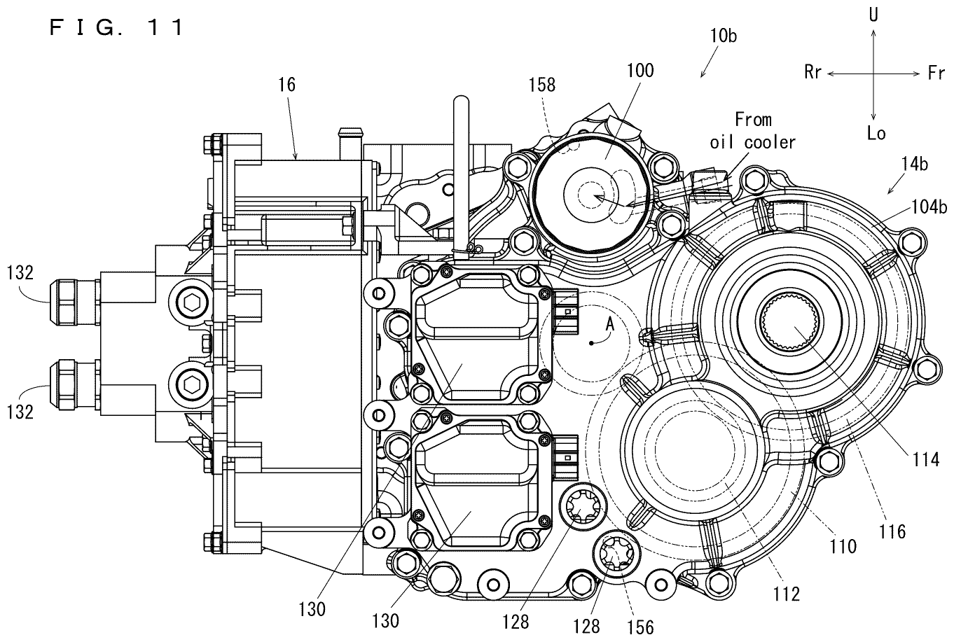

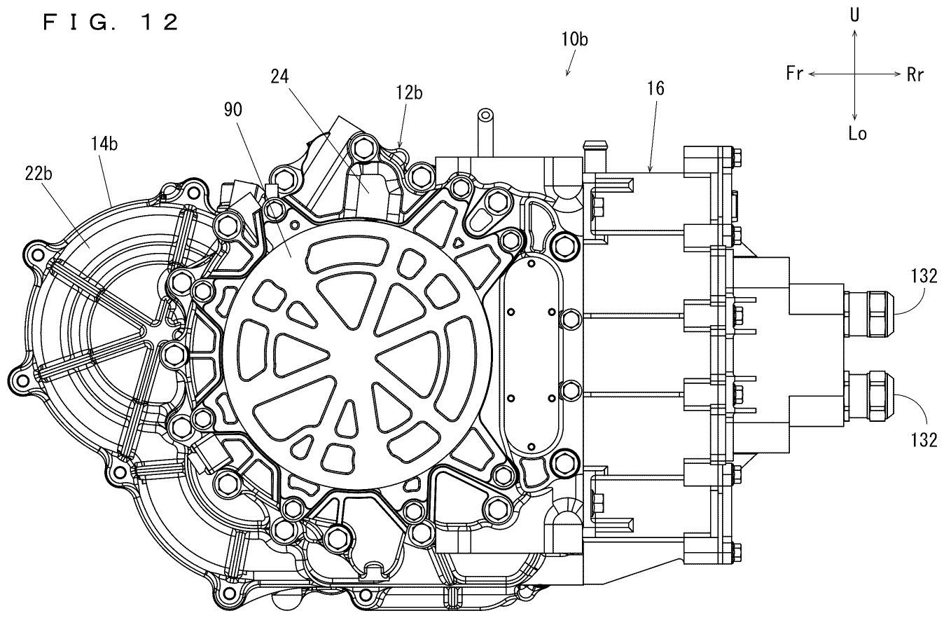

Referring to FIG. 2, the motor unit 10a and the motor unit 10b are in or substantially in left-right symmetry, with the motor unit 10b being configured in a similar manner as the motor unit 10a. With this arrangement in mind, as shown in FIG. 9 through FIG. 14, components in the motor unit 10b which are identical with those in the motor unit 10a are given identical reference symbols with those in the motor unit 10a, while components which are similar to those in the motor unit 10a are given the same reference symbols with those in the motor unit 10a, except that their suffix “a” at the end of each reference symbol changed to “b”, and no repetitive description will be repeated here. Specifically, in the motor unit 10b, an inverter 16, a stator housing 20, a second motor cover 24, a branched portion 30, a first external pipe 32, a second external pipe 36, a rotor 40, a stator 60, a cover 90, an oil filter 100, oil pumps 130, etc. are identical with those included in the motor unit 10a.

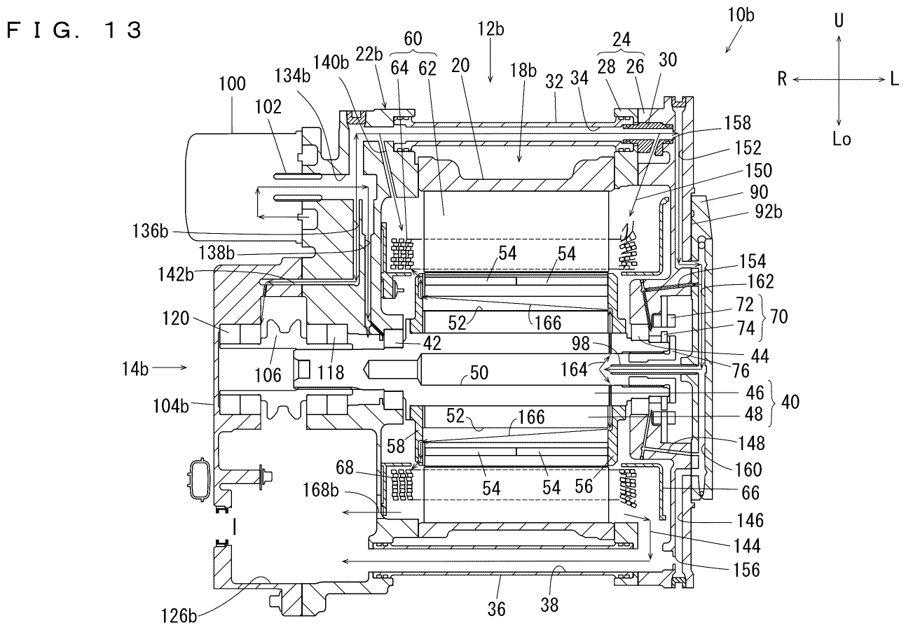

As understood from FIG. 7 and FIG. 13, in the motor unit 10b, the stator housing 20 and the second motor cover 24 of the motor unit 10a are rotated by 180 degrees (flipped upside down), and the first external pipe 32 and the branched portion 30 are swapped with the second external pipe 36, and further, the first motor cover 22a and the speed reducer 14a are replaced with a first motor cover 22b and a speed reducer 14b.

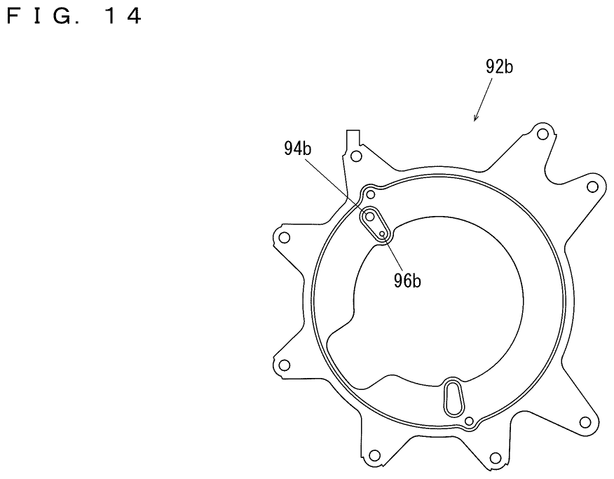

Referring to FIG. 14, a second gasket 92b between the second motor cover 24 and the cover 90 has an annular or substantially annular shape, and includes through-holes 94b, 96b that connect oil paths. In other words, the gasket 92b connects the oil path 152 to the oil path 162, and the oil path 162 to the oil path 154 by the through-holes 94b, 96b, but does not connect the oil path 146 to the oil path 160, and the oil path 160 to the oil path 148.

In the motor unit 10b, the oil paths 150, 152 are connected to the outward oil path 34 via the branched portion 30. Also, the open end 158 of the oil path 152 is connected to an exit-end of the first external pipe 32 via the branched portion 30, while the open end 156 of the oil path 146 is connected to an inlet-end of the second external pipe 36.

In the motor unit 10b, the oil paths inside the second motor cover 24 and the upper half of the cover 90 in the state shown in FIG. 13 are utilized.

Oil which flows through the outward oil path 34 and is supplied to the second motor cover 24 is divided by the branched portion 30, supplied to the coil end of the stator coil 64 via the oil path 150, and sent toward the cover 90 via the oil path 152. The oil path 162 connects the oil paths 152 and 154 with each other. In other words, the oil path 152 and the oil path 162 communicate with each other via the through-hole 94b of the gasket 92b, while the oil path 162 and the oil path 154 communicate with each other via the through-hole 96b of the gasket 92b. Therefore, the oil paths 152 and 154 of the second motor cover 24 communicate with each other via the oil path 162 of the cover 90, and oil from the oil path 152 is supplied to the motor bearing 44 and its surroundings via the oil paths 162, 154. Also, the oil path 162 communicates with the oil path 164 inside the hollow portion 50 of the rotor shaft 46 via the pipe 98, and further, communicates with the oil path 166 which leads to the coil end of the stator coil 64, via the rotor core hole 52. Therefore, oil from the oil path 162 is supplied to the coil end of the stator coil 64 via the oil paths 164, 166. As described, oil from the outward oil path 34 is supplied into the case 18b via the second motor cover 24 and the cover 90.

Oil which is supplied to the coil end of the stator coil 64 is then supplied to an oil reservoir 126b via the oil path 144 and the return oil path 38, or via an oil path 168b of the first motor cover 22b. Oil in the oil reservoir 126b is pumped by the two oil pumps 130, supplied to and cooled by the shared oil cooler, and then returned to the oil filter 100.

In a preferred embodiment, the first external pipe 32 corresponds to the first pipe. The second external pipe 36 corresponds to the second pipe. The oil path 164 corresponds to the first oil path. The oil path 146 corresponds to the second oil path. The oil path 152 corresponds to the third oil path. The oil path 160 corresponds to the fourth oil path. The oil path 162 corresponds to the fifth oil path. The oil path 144 corresponds to the sixth oil path. The oil path 150 corresponds to the seventh oil path.

According to the vehicle driving motor unit 5, or the electric vehicle 1 in general, two motors 12, 12b, or the motor units 10a, 10b are used in a side-by-side layout. In this arrangement, a first one of the motors, i.e., the motor 12a is disposed so that the oil path 146 is at a higher position than the oil path 152, the first external pipe 32 has its exit-end in communication with the open end 156 of the oil path 146, and the second external pipe 36 has its inlet-end in communication with the open end 158 of the oil path 152. The gasket 92a between the second motor cover 24 and the cover 90 provides communication between the oil path 146 and the oil path 160 via the through-hole 94a but blocks communication between the oil path 152 and the oil path 162. Therefore, oil from the outward oil path 34 of the first external pipe 32 is supplied into the case 18a via the oil path 146 of the second motor cover 24, the oil path 160 of the cover 90, and the oil path 164 of the rotor 40. In this arrangement, oil does not flow from the oil path 152 to the oil path 162. In a second one of the motors, i.e., in the motor 12b, the stator housing 20 and the second motor cover 24 of the first motor 12a are rotated by 180 degrees (flipped upside down), and the first external pipe 32 and the second external pipe 36 are swapped with each other. In other words, the second motor 12b is disposed so that the oil path 152 is at a higher position than the oil path 146, the first external pipe 32 has its exit-end in communication with the open end 158 of the oil path 152, and the second external pipe 36 has its inlet-end in communication with the open end 156 of the oil path 146. The gasket 92b provides communication between the oil path 152 and the oil path 162 via the through-hole 94b but blocks communication between the oil path 146 and the oil path 160. Therefore, oil from the outward oil path 34 is supplied into the case 18b via the oil path 152 of the second motor cover 24, the oil path 162 of the cover 90, and the oil path 164 of the rotor. In this arrangement, oil does not flow from the oil path 146 to the oil path 160. As described above, it is possible by the use of the gaskets 92a, 92b to change an oil route from the outward oil path 34 to the oil path 164 so that the route is provided by the oil path which is on a gravitationally upper side, thus making it possible to suitably use the two motors 12a, 12b in a side-by-side layout.

In the first motor 12a oil from the outward oil path 34 is smoothly supplied to the stator coil 64 via the oil path 144 of the second motor cover 24, while in the second motor 12b oil from the outward oil path 34 is smoothly supplied to the stator coil 64 via the oil path 150 of the second motor cover 24. As described above, it is possible to switch between the two oil paths to the stator coil 64, and it is possible to smoothly supply oil to the stator coil 64 too.

In the first motor 12a, the branched portion 30 is attached between the outward oil path 34 and the oil paths 146, 144 such that it is possible to easily divide oil from the outward oil path 34 to the oil paths 146, 144. In the second motor 12b, the branched portion 30 is attached between the outward oil path 34, and the oil paths 152, 150 such that it is possible to easily divide oil from the outward oil path 34 to the oil path 152 and to the oil path 150.

When viewed axially along the rotor 40, the open end 156 of the oil path 146 and the open end 158 of the oil path 152 are in point symmetry about the axis A of the rotor 40. Therefore, even if the motor is rotated by 180 degrees (flipped upside down), it is possible to supply oil into the cases 18a, 18b from a similar position. Also, the positional relationship between the branched portion 30 connected with the open end 156 and the coil end in the motor unit 10a, and the positional relationship between the branched portion 30 connected with the open end 158 and the coil end in the motor unit 10b are similar or substantially similar to each other. In other words, even if the motor is rotated by 180 degrees (flipped upside down), the positional relationship between the coil end and an oil injection hole of the branched portion 30 stays the same or substantially the same. Therefore, it is possible with the motor units 10a and 10b to supply oil to the coil ends in a similar manner.

Since the speed reducers 14a, 14b communicate with the return oil path 38, it is possible to smoothly supply oil to the speed reducers 14a, 14b.

Both motors 12a, 12b, and therefore both motor units 10a, 10b, use identical stator housings 20, second motor covers 24, and covers 90. Therefore, it is possible to easily obtain the vehicle driving motor unit 5 including a plurality of the motor units 10a, 10b.

The vehicle driving motor unit 5 described above can be suitably utilized in the electric vehicle 1.

It should be noted here that in the motor unit 10a, the oil path 146 may communicate with the outward oil path 34 without the branched portion 30 in between. In other words, the open end 156 of the oil path 146 may communicate with the exit-end of the first external pipe 32 without the branched portion 30 in between. The oil path 144 may also communicate with the outward oil path 34 without the branched portion 30 in between.

In the motor unit 10b, the oil path 152 may communicate with the outward oil path 34 without the branched portion 30 in between. In other words, the open end 158 of the oil path 152 may communicate with the exit-end of the first external pipe 32 without the branched portion 30 in between. The oil path 150 may also communicate with the outward oil path 34 without the branched portion 30 in between.

The first pipe and the second pipe are not limited to the first external pipe 32 and the second external pipe 36 respectively, but they may be provided by pipes provided inside the cases 18a, 18b.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor comprising:
a case including a stator housing, a first motor cover at an output end of the stator housing, and a second motor cover at a non-output end of the stator housing;
a first pipe including an outward oil path and held by the first motor cover and the second motor cover;
a second pipe including a return oil path, located lower than the first pipe, and held by the first motor cover and the second motor cover;
a rotor inside the case and including a first oil path;
a stator inside the case and including a stator core radially outside the rotor, and a stator coil in the stator core;
a cover outside the second motor cover; and
a gasket between the second motor cover and the cover; wherein
the second motor cover includes a second oil path and a third oil path connected to the outward oil path;
the cover includes a fourth oil path between the first oil path and the second oil path, or a fifth oil path between the first oil path and the third oil path;
the gasket includes a through-hole to connect either the second oil path and the fourth oil path, or connect the third oil path and the fifth oil path; and
the second oil path includes an open end and the third oil path includes an open end respectively connected to one of an exit end of the first pipe and the other of an inlet end of the second pipe.

2. The motor according to claim 1, wherein
the second motor cover further includes a sixth oil path and a seventh oil path connected to the outward oil path to supply oil to the stator coil; and
the sixth oil path is adjacent to the second oil path, and the seventh oil path is adjacent to the third oil path.

3. The motor according to claim 2, further comprising:
a branched portion inside the second motor cover to direct the oil from the outward oil path to the second oil path and the sixth oil path, or to the third oil path and the seventh oil path.

4. The motor according to claim 1, wherein the open ends of the second oil path and the third oil path are in point symmetry to each other with respect to an axis of the rotor when viewed axially along the rotor.

5. A motor unit comprising:
the motor according to claim 1; and
a speed reducer on a side of the first motor cover to slow rotation of the rotor, and connected to the return oil path.

6. A vehicle driving motor unit comprising:
a plurality of the motor unit according to claim 5; wherein
the stator housing, the second motor cover, and the cover in each of the motors are identical.

7. An electric vehicle comprising:
the vehicle driving motor unit according to claim 6.
